(19) United States
(12) Patent Application Publication
(10) Pub. No.: US 2009/0128623 A1
(43) Pub. Date: May 21, 2009

(54) Hull-mounted underwater camera remote monitoring system for vessel running gear

(76) Inventor: Gregory Whittle, Everett, WA (US)

Correspondence Address: Donald W. Meeker;Patent Agent, 924 East Ocean Front #E, Newport Beach, CA, 92661, US

(21) Appl. No.: 11/985,365

(22) Filed: Nov. 15, 2007

(51) Int. Cl. H04N 7/18

(52) U.S. Cl. 348/81; 348/E07.085

(57) ABSTRACT

A top shell attaches to a bottom of a hull of a boat. A bottom shell attaches to the top shell with a waterproof camera housed between the shells. A cable runs from the camera to a monitoring screen in the pilot area.

### CROSS-REFERENCE TO RELATED APPLICATIONS

The present utility patent application claims the benefit of provisional application No. 60/862,021 filed Oct. 18, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to underwater video equipment and particularly to a live monitoring system for the running gear under a vessel; the system comprises a video camera contained within a housing attached to a hull or keel of a boat, the camera being connected to a video monitor in the wheelhouse for remotely viewing the stabilizers, propeller(s), shaft and rudder of the vessel.

2. Description of Related Art Including Information Disclosed Under 37 CFR 1.97 and 1.98

Underwater photography has long been used as a valuable tool in determining the condition of ship hulls below the water level. U.S. Pat. No. 631,222 to Mason shows an early example of photographic apparatus for such purposes.

One method of inspecting a hull is to send a diver down to make a visual inspection of the underside of the vessel. Examples are shown in U.S. Pat. Nos. 3,776,574; 4,102,203; 5,048,445; 5,353,054; 5,678,091 which relate a process for the inspection of a submerged vessel whereby a diver employs a motion picture camera connected to a transmission cable to record the condition of the hull while submerged underwater, this however requires many hours.

Others methods of inspecting the underside of a vessel are to use a submersible remotely operated vehicle or to have a video monitoring system underwater in locks or a dry dock. Examples of these devices can be found in U.S. Pat. Nos. 7,102,665; 7,044,074; 7,072,244; 6,854,410; 6,712,017; 6,707,761; 6,317,387; 5,947,051; 5,048,445; 4,821,665; 4,308,600; 3,922,991; 3,780,220 and 3,757,042. These underwater hull inspection systems are cost prohibitive and are not affordable for the average boat owner.

Two U.S. Pat. No. 6,115,060 issued Sep. 5, 2000 and U.S. Pat. No. 6,100,921 issued Aug. 8, 2000 to Rowley, provide a video camera assembly which is adapted to be mounted in a thru-hull fitting so as to allow for safe and dependable viewing in various environments. A primary embodiment of the invention allows for directing the focus of the camera toward alternative fields of view by incorporation of the device within a conventional thru-hull fitting found on most boats. The camera includes a modified transducer body with a self-contained miniaturized camera available for coupling to a television or video monitor in a safe and protected location.

U.S. Pat. No. 7,106,359, issued Sep. 12, 2006 to Fantone, is for, a subsurface video observation system, useful for location of fish and other plant and animal life underwater, comprises a solid state imager having substantial sensitivity to infrared radiation; video signal generating means for generating a video signal corresponding to the image formed on the solid state imager; mounting means for mounting the solid state imager on a submersible portion of a watercraft; and a video display device arranged to display a visible image corresponding to the image formed on the solid state imager. In FIG. 3, an embodiment is shown with an imager housing attached to the keel.

U.S. Pat. No. 6,348,942, issued Feb. 19, 2002 to Watkins, claims a system for enhancing underwater visibility that uses left and right alternately chopped laser illumination, filtered wide baseline stereo imaging and specular reflectors for deblurring the images. If a vessel has a wide enough girth, the laser and camera pairs may be mounted directly to the hull of the ship. Two stereo images are compared to determine the pattern of backscattered light and the resultant backscatter pattern is subtracted from the images. Inverse point spread filtering based on the fusion of the specular reflector pattern is next performed to further improve the images, and stereoscopic is display for enhanced visibility in turbid and murky mediums. The invention has broad application for underwater exploration and search and recovery operations, and is especially useful for detection and removal of underwater mine hazards.

U.S. Patent Application #20060158549, published Jul. 20, 2006 by Digweed, shows a remote viewing apparatus comprising: a monitor which operatively displays a picture using a video signal; a telescopic pole; and a unit including a camera which operatively outputs a video signal to be used by the monitor; a waterproof camera housing in which the camera is enclosed; a wand which is releasably retained at one end of the telescopic pole; and a pliable mechanical connector which connects the camera housing to the wand and which can be reversibly bent by hand to, and retain, a curved shape. A plurality of interchangeable units can be provided with additional units having the pliable connector bifurcated in to two arms with the camera housing being provided on one of the arms and an auxiliary device provided on the other of the arms. Examples of auxiliary devices are light sources and magnets.

U.S. Patent Application #20070137544, published Jun. 21, 2007 by MacDonald, is for a two piece view port and light housing suitable for installation under the water line of a vessel wherein the view port comprises a flange made from a corrosion resistant material and a body made from a heat resistant material. An alternative embodiment of the invention is an underwater light in which a high intensity light and ballast is completely installed into the above mentioned view port. It is also an object of the invention that the assembly may be alternatively used to house a camera rather than a light.

U.S. Patent Application #20060239013, published Oct. 26, 2006 by Olsson, provides a thru-hull fitting assembly which is connected to the forward end of a hollow lamp housing for mounting to a hole in the hull of a vessel in a water-tight fashion. An HID or other lamp is mounted in the lamp housing and is surrounded by a reflector which may have an outer elliptical section and an inner parabolic section. A protective transparent window extends across the forward end of the lamp housing and is sealed thereto. The window may be made of sapphire to provide improved heat dissipation and to resist scratching during hull cleaning and breakage due to thermal shock and wave slap. A circuit may be connected to the lamp to provide over-heat protection, leak detection, as well as fault and power status indicators. Alternate embodiments utilize a solid light pipe or a hollow reflective tube to convey light from the lamp to the protective window. The lamp could be replaced with a camera or there could be a combination of a camera and a device for illuminating the field of view of the camera.

U.S. Patent Application #20060055786, published Mar. 16, 2006 by Ollila, claims a communication system and device, such as wiring harness for a portable point-of-view camera which includes a power cord, a recording cord and a camera cord and other devices to facilitate receipt, transference, or recordation of communication signals and information. The three cords may be mutually interconnected and can be respectively joined with a power source, a recording device, and a camera. A microphone or other devices may be integrated into or associated with the wiring harness or the camera. The technology may be directed to, for example, activities such as law enforcement operations; military operations; and counter-terrorism measures and operations. Ollila mentions that the camera may be mounted to the hull of a kayak.

U.S. Pat. No. 7,044,623, issued May 16, 2006 to Olsson, shows a thru-hull fitting assembly which is connected to the forward end of a hollow lamp housing for mounting to a hole in the hull of a vessel in a water-tight fashion. An HID or other lamp is mounted in the lamp housing and is surrounded by a reflector which may have an outer elliptical section and an inner parabolic section. A protective transparent window extends across the forward end of the lamp housing and is sealed thereto. The window may be made of sapphire to provide improved heat dissipation and to resist scratching during hull cleaning and breakage due to thermal shock and wave slap. A circuit may be connected to the lamp to provide over-heat protection, leak detection, as well as fault and power status indicators. Alternate embodiments utilize a solid light pipe or a hollow reflective tube to convey light from the lamp to the protective window. The lamp could be replaced with a camera or there could be a combination of a camera and a device for illuminating the field of view of the camera.

What is needed is a permanently mounted live video type waterproof camera mounted on a bottom of a boat hull for monitoring the running gear of the boat with a viewing screen in the pilot area.

### BRIEF SUMMARY OF THE INVENTION

The primary object of the present invention is to provide a permanently mounted live video type waterproof camera mounted on a bottom of a boat hull for monitoring the running gear of the boat with a viewing screen in the pilot area.

In brief, the present invention is a live monitoring system for the running gear under a vessel. The system comprises a video camera contained within a housing attached to a hull or keel of a boat, the camera being connected to a video monitor in the wheelhouse for remotely viewing the stabilizers, propeller(s), shaft and rudder of the vessel.

An advantage of the present invention is that the system provides constant monitoring of the running gear of the boat.

Another advantage of the present invention is that the camera can be accessed for repairs or replacement by removing the bottom shell.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the live under-hull monitoring system of the present invention mounted under the hull of a boat showing the camera pod and cable (dashed) connected between the camera and a monitoring screen in the pilot area;

FIG. 2 is a side elevational view of the camera pod of the system of FIG. 1;

FIG. 3 is a bottom plan view of the top shell of the camera pod of FIG. 2.

### DETAILED DESCRIPTION OF THE INVENTION

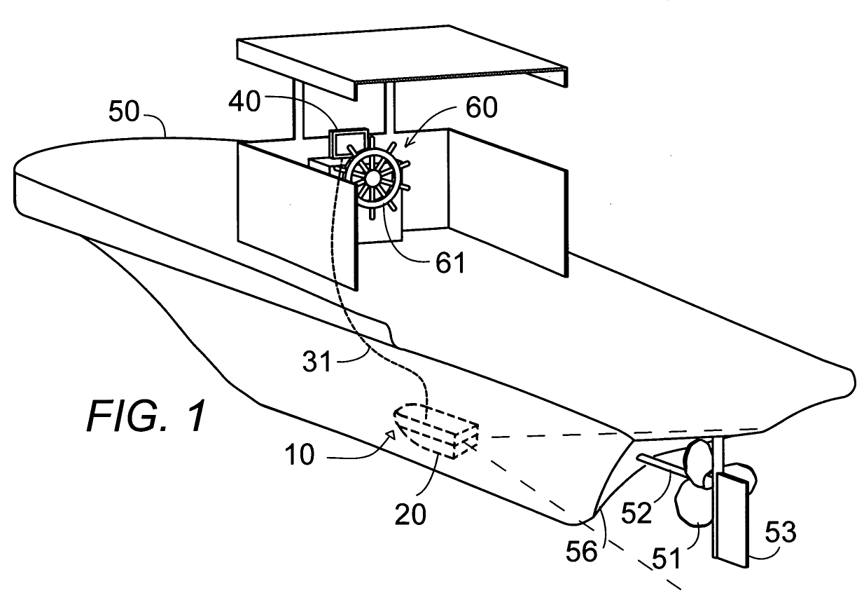

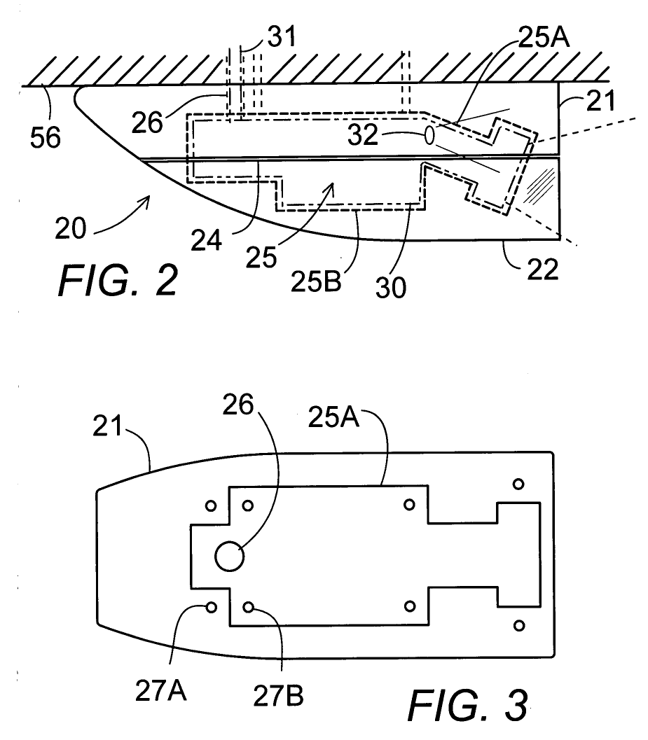

In FIGS. 1-3, a live monitoring system 10 for constantly monitoring the running gear under a vessel including at least one drive screw 51, at least one drive shaft 52, at least one rudder 53, at least one stabilizer, and any scientific equipment or other equipment attached to or adjacent to the bottom of the hull 56.

A camera pod 20 is mounted to a bottom 56 of a hull of a boat 50. The pod 20 comprises a top shell 21 mounted to the bottom 56 of the hull of the boat and a bottom shell 22 mounted to the top shell with a watertight seal therebetween along the sealed planar interconnection 24. The pair of shells have a shared opening 25 therein between the shells with a top shell opening 25A communicating with a bottom shell opening 25B. The shared opening 25 is structured in a shape of the camera 30 to secure the camera therein for viewing and recording the running components of the boat extending from the hull underwater in real time. The camera pod 20 comprises at least one transparent portion of the pod through which the camera is pointed (angled dashed lines) in the direction of the running gear for recording the real time operation of the running gear. The entire pod 20 may be transparent.

The cable 31 runs from the camera 30 through a sealed opening 26 in the top shell 21 and through another sealed opening through the hull to a deck of the boat to a viewing screen 40 on the boat in the pilot area 60 adjacent to the boat running controls including the wheel 61. The viewing screen 40 is connected to the cable 31 for receiving real time images of the underwater running components.

The camera pod 20 is secured to the hull 56 with a waterproof sealed connection therebetween so that the camera is constantly viewing the running gear including at least one drive screw 51, at least one drive shaft 52, at least one rudder 53, and at least one stabilizer as well as any scientific or other equipment.

The cable 31 comprises both a power transmission line to the camera 30 to power the camera and a video signal transmission line to transmit video signals to the monitor 40.

A means for lighting the running gear is housed within the pod and preferably comprises led lighting 32 in the camera.

The pod 20 is structured with a curved forward end comprising a hydro dynamically shaped outer contour to flow through the water with a minimal amount of drag.

The top shell 21 is attached to the bottom of the hull 56 by a series of threaded fasteners through watertight holes 27B in the top shell into a series of mating watertight holes in the hull and the bottom shell 21 is attached to the top shell by a series of threaded fasteners through watertight openings 27A in the bottom shell 22 into mating openings in the top shell 21.

The pod preferably comprising a waterproof camera 30 housed within the pod.

The pod is preferably made from UHMW but could be made from other materials in a two part clam shell configuration. It splits down the middle horizontally and is attached to any surface with bolts or lag screws and the halves are held together with bolts. The actual dimensions of the pod/camera assembly could easily be changed so as to accommodate different size cameras.

The pod and camera system would mount to the exterior of a boat's hull and would allow for permanent monitoring of the vessels underwater systems.

It is understood that the preceding description is given merely by way of illustration and not in limitation of the invention and that various modifications may be made thereto without departing from the spirit of the invention as claimed.

What is claimed is:

1. A live monitoring system for the running gear under a vessel, the system comprising:
a camera pod mounted to a bottom of a hull of a boat, the pod comprising a top shell mounted to a bottom of a boat; a bottom shell mounted to the top shell with a watertight seal therebetween; the pair of shells having a shared opening therein between the shells and sealed therebetween, the shared opening structured in a shape of a camera to secure the camera therein for viewing and recording the running components of the boat extending from the hull underwater in real time, the pod further comprising at least one transparent portion of the pod through which the camera is pointed in the direction of the running gear for recording the real time operation of the running gear;
a cable running from the camera through a sealed opening in the top shell and through another sealed opening through the hull to a deck of the boat;
a viewing screen on the boat adjacent to the boat running controls, the viewing screen connected to the cable for receiving real time images of the underwater running components.

2. The system of claim 1 wherein the camera pod is secured to the hull with a waterproof sealed connection therebetween so that the camera contained in the pod is constantly viewing the running gear including at least one drive screw, at least one drive shaft, at least one rudder, and at least one stabilizer.

3. The system of claim 1 wherein the cable comprises a power transmission line to the camera to power the camera and a video signal transmission line to transmit video signals to the monitor.

4. The system of claim 1 further comprising means for lighting the running gear housed within the pod.

5. The system of claim 4 wherein the means for lighting comprises led lighting in the camera.

6. The system of claim 1 wherein the pod is structured with a hydro dynamically shaped outer contour to flow through the water with a minimal amount of drag.

7. The system of claim 1 wherein the top shell is attached to the hull by a series of threaded fasteners through watertight holes in the top shell into a series of mating watertight holes in the hull and the bottom shell is attached to the top shell by a series of threaded fasteners through watertight openings in the bottom shell into mating openings in the top shell.

8. The system of claim 1 further comprising a waterproof camera housed within the pod.
